(19) United States
(12) Patent Application Publication
(10) Pub. No.: US 2025/0192591 A1
(43) Pub. Date: Jun. 12, 2025

(54) FIRST ELECTRONIC DEVICE FOR RECEIVING POWER FROM SECOND ELECTRONIC DEVICE, METHOD THEREFOR, AND SECOND ELECTRONIC DEVICE FOR TRANSMITTING POWER TO FIRST ELECTRONIC DEVICE

(71) Applicant: SAMSUNG ELECTRONICS CO., LTD., Suwon-si (KR)

(72) Inventors: Taehyun WOO, Suwon-si (KR); Hyunggon KIM, Suwon-si (KR); Seungho LEE, Suwon-si (KR); Jaesung LEE, Suwon-si (KR); Juhyang LEE, Suwon-si (KR); Hyekyung JEON, Suwon-si (KR)

(73) Assignee: SAMSUNG ELECTRONICS CO., LTD., Suwon-si (KR)

(21) Appl. No.: 19/030,901

(22) Filed: Jan. 17, 2025

Related U.S. Application Data
(63) Continuation of application No. PCT/KR2023/008842, filed on Jun. 26, 2023.

(30) Foreign Application Priority Data
Jul. 29, 2022 (KR) 10-2022-0094693
Aug. 9, 2022 (KR) 10-2022-0099566

(51) Int. Cl. H02J 7/00; H02J 50/00; H04R 1/10

(52) U.S. Cl. CPC H02J 7/0068; H02J 7/0048; H02J 50/00; H04R 1/1025; H04R 2420/07

(57) ABSTRACT

A first electronic device includes a first interface, a dummy load connected to the first interface, a first battery connected to the first interface and the dummy load, and a controller connected to the dummy load, where the controller is configured to receive power from a second electronic device through the first interface, identify a state of charge (SOC) of the second electronic device based on a packet received from the second electronic device through the first interface, and based on identifying that the SOC of the second electronic device is larger than a predetermined value and that the first battery is fully charged, conduct a direct current (DC) having a predetermined magnitude to the dummy load.

### CROSS-REFERENCE TO RELATED APPLICATIONS

This application is a bypass continuation of International Application No. PCT/KR2023/008842, filed on Jun. 26, 2023, in the Korean Intellectual Property Receiving Office, which is based on and claims priority to Korean Patent Application No. 10-2022-0099566, filed on Aug. 9, 2022, in the Korean Intellectual Property Office, and Korean Patent Application No. 10-2022-0094693, filed on Jul. 29, 2022, in the Korean Intellectual Property Office, the disclosures of which are incorporated herein by reference in their entireties.

### BACKGROUND

### 1. Field

The disclosure relates to a first electronic device receiving power from a second electronic device, an operation method thereof, and the second electronic device transmitting power to the first electronic device.

### 2. Description of Related Art

As wireless communication technology advances, an electronic device may communicate with another electronic device via various wireless communication techniques. Bluetooth communication technology may refer to short-range wireless communication technology that may interconnect electronic devices to exchange data or information. Bluetooth communication technology may have Bluetooth legacy (or classic) network technology or Bluetooth low energy (BLE) network technology and have various kinds of topology, such as piconet or scatternet. Electronic devices may share data at low power using Bluetooth communication technology.

Such Bluetooth technology may be used to connect external wireless communication devices and transmit audio data for the content running on the electronic device to an external wireless communication device so that the external wireless communication device may process the audio data and output the result to the user. Bluetooth communication technology-adopted wireless earphones are recently in wide use.

The wireless earphones may be stored while inserted or mounted in the cradle. Further, the wireless earphones may be charged while mounted in the cradle. To that end, the cradle may include a battery. The cradle may transmit power stored in the battery to the wireless earphones. Further, the cradle may wirelessly or wiredly receive power from an external electronic device. In this case, the cradle may transmit power to the wireless earphones while charging the battery included in the cradle.

### SUMMARY

According to an aspect of the disclosure, a first electronic device may include a first interface, a dummy load connected to the first interface, a first battery connected to the first interface and the dummy load, and a controller connected to the dummy load, where the controller is configured to receive power from a second electronic device through the first interface, identify a state of charge (SOC) of the second electronic device based on a packet received from the second electronic device through the first interface, and based on identifying that the SOC of the second electronic device is larger than a predetermined value and that the first battery is fully charged, conduct a direct current (DC) having a predetermined magnitude to the dummy load.

The controller may be configured to conduct the DC to the dummy load until a second battery of the second electronic device is fully charged.

The controller may be further configured to, based on the second battery being fully charged or power reception from the second electronic device being stopped, stop conducting the DC to the dummy load.

The controller may be further configured to, based on the first battery being fully charged, periodically conduct an alternating current (AC) having a predetermined magnitude to the dummy load, and based on identifying that the SOC of the second electronic device is larger than the predetermined value and that the first battery is fully charged, conduct the DC to the dummy load and stop conducting the AC to the dummy load.

The controller may be further configured to obtain the packet by receiving a signal magnitude-modulated with respect to a reference voltage or a reference current from the second electronic device through the first interface.

The controller may be configured to conduct the DC to the dummy load based on a command received from the second electronic device.

The controller may be further configured to obtain the command through the packet.

The first electronic device may include an optical element, and the controller may be configured to output light through the optical element based on identifying that the SOC of the second electronic device is larger than the predetermined value and that the first battery is fully charged.

The second electronic device may be configured to wirelessly receive power from an outside.

The first electronic device may include a wireless earphone, and the second electronic device may include a cradle on which the wireless earphone is mounted.

According to an aspect of the disclosure, a method of operating a first electronic device that includes a first interface, a dummy load, and a first battery, may include receiving power from a second electronic device through the first interface of the first electronic device, identifying a SOC of the second electronic device based on a packet received from the second electronic device through the first interface, and based on identifying that the SOC of the second electronic device is larger than a predetermined value and that the first battery is fully charged, conducting a DC having a predetermined magnitude to the dummy load.

The method may include conducting the DC to the dummy load until a second battery of the second electronic device is fully charged.

The method may include, based on the second battery being fully charged or power reception from the second electronic device being stopped, stopping conducting the DC to the dummy load.

The conducting the DC to the dummy load may include, based on the first battery being fully charged, periodically conducting an AC having a predetermined magnitude to the dummy load, and based on identifying that the SOC of the second electronic device is larger than the predetermined value and that the first battery is fully charged, conducting the DC to the dummy load and stopping conducting the AC to the dummy load.

The identifying the SOC of the second electronic device may include obtaining the packet by receiving a signal magnitude-modulated with respect to a reference voltage or a reference current from the second electronic device through the first interface.

The conducting the DC to the dummy load may include conducting the DC to the dummy load based on a command received from the second electronic device.

The method may include outputting light through an optical element included in the electronic device based on identifying that the SOC of the second electronic device is larger than the predetermined value and that the first battery is fully charged.

According to an aspect of the disclosure, a second electronic device may include a coil, a second interface, a rectifier circuit including a plurality of switches connected to the coil, a regulator connected to the rectifier circuit, a second battery connected to the regulator, and a controller connected to the second battery, the controller configured to while wirelessly receiving power from an external electronic device through the coil, transmit power to a first electronic device through the second interface, transmit information on a SOC of the second battery to the first electronic device through the second interface, when a size of current output from the regulator is greater than a designated current value, transmit a first command to the first electronic device so that the first electronic device conducts a DC having a designated size to a dummy load included in the first electronic device, and control the rectifier circuit so that the plurality of switches operate as a full bridge circuit until the second battery is fully charged when the SOC of the second battery is greater than a designated value.

The controller may be configured to transmit a second command to the first electronic device so that, when the second battery is fully charged, the first electronic device stops conducting the DC to the dummy load included in the first electronic device.

The controller may be configured to control the rectifier circuit so that, while a constant voltage is applied to the second battery, the plurality of switches operate as the full bridge circuit,

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an electronic device in a network environment according to various embodiments;

FIGS. 2A and 2B are diagrams illustrating a charging system according to one or more embodiments;

FIG. 3 is a block diagram illustrating a first electronic device, a second electronic device, a third electronic device, and a TX device according to one or more embodiments;

FIG. 4 is a flowchart illustrating a method for operating a first electronic device according to one or more embodiments;

FIG. 5 is a flowchart illustrating a method for operating a second electronic device according to one or more embodiments;

FIG. 6 is a flowchart illustrating a method for operating a first electronic device according to one or more embodiments;

FIG. 7 is a flowchart illustrating a method for operating a second electronic device according to one or more embodiments;

FIG. 8 is a diagram illustrating a data flow for illustrating data transmitted/received by a first electronic device and a second electronic device according to one or more embodiments;

FIG. 9 is a diagram illustrating a data flow for illustrating data transmitted/received by a first electronic device and a second electronic device according to one or more embodiments; and

FIG. 10 illustrates graphs showing a battery voltage and a battery current of a second electronic device according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

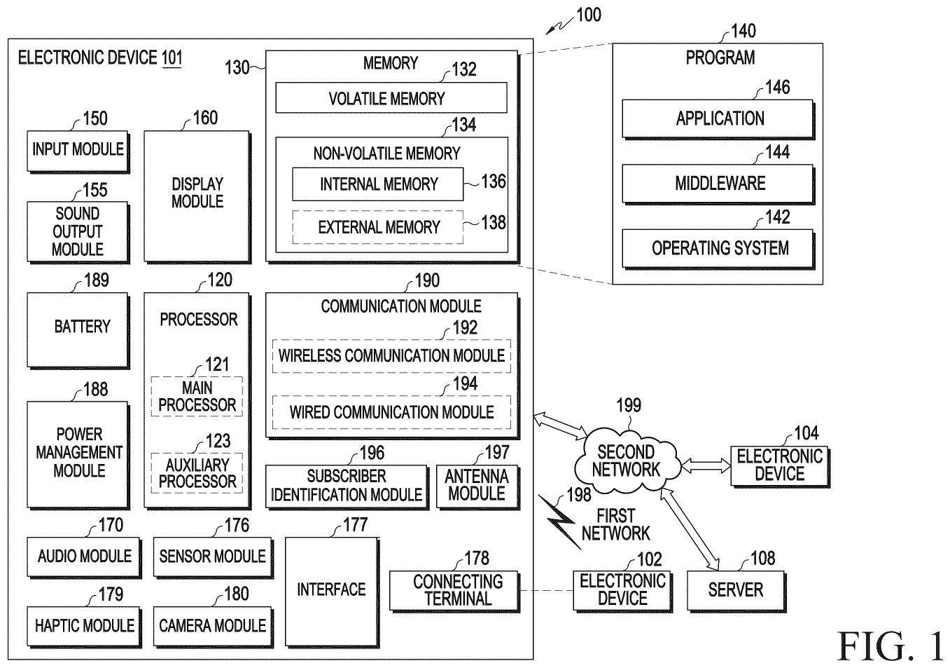

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to one or more embodiments, the electronic device 101 may communicate with the electronic device 104 via the server 108. According to one or more embodiments, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one (e.g., the connecting terminal 178) of the components may be omitted from the electronic device 101, or one or more other components may be added in the electronic device 101. According to one or more embodiments, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one or more embodiments, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one or more embodiments, the auxiliary processor 123 (e.g., an image signal processor or a communication processor) may be implemented as part of another component (e.g., the camera module 180 or the communication module 190) functionally related to the auxiliary processor 123. According to one or more embodiments, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to one or more embodiments, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to one or more embodiments, the display module 160 may include a touch sensor configured to detect a touch, or a pressure sensor configured to measure the intensity of a force generated by the touch.

The audio module 170 may convert a sound into an electrical signal and vice versa. According to one or more embodiments, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to one or more embodiments, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to one or more embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to one or more embodiments, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to one or more embodiments, the haptic module 179 may include, for example, a motor, a piezoelectric element, or an electric stimulator.

The camera module 180 may capture a still image or moving images. According to one or more embodiments, the camera module 180 may include one or more lenses, image sensors, image signal processors, or flashes.

The power management module 188 may manage power supplied to the electronic device 101. According to one or more embodiments, the power management module 188 may be implemented as at least part of, for example, a power management integrated circuit (PMIC).

The battery 189 may supply power to at least one component of the electronic device 101. According to one or more embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to one or more embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna.

The wireless communication module 192 may support various requirements specified in the electronic device 101, an external electronic device (e.g., the electronic device 104), or a network system (e.g., the second network 199). According to one or more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to one or more embodiments, the antenna module 197 may include one antenna including a radiator formed of a conductor or conductive pattern formed on a substrate (e.g., a printed circuit board (PCB)). According to one or more embodiments, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to one or more embodiments, other parts (e.g., radio frequency integrated circuit (RFIC)) than the radiator may be further formed as part of the antenna module 197.

According to various embodiments, the antenna module 197 may form a mmWave antenna module. According to one or more embodiments, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, commands or data may be transmitted or received between the electronic device 101 and the external electronic device 104 via the server 108 coupled with the second network 199. The external electronic devices 102 or 104 each may be a device of the same or a different type from the electronic device 101. According to one or more embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to one or more embodiments, the external electronic device 104 or the server 108 may be included in the second network 199. The electronic device 101 may be applied to intelligent services (e.g., smart home, smart city, smart car, or health-care) based on 5G communication technology or IoT-related technology.

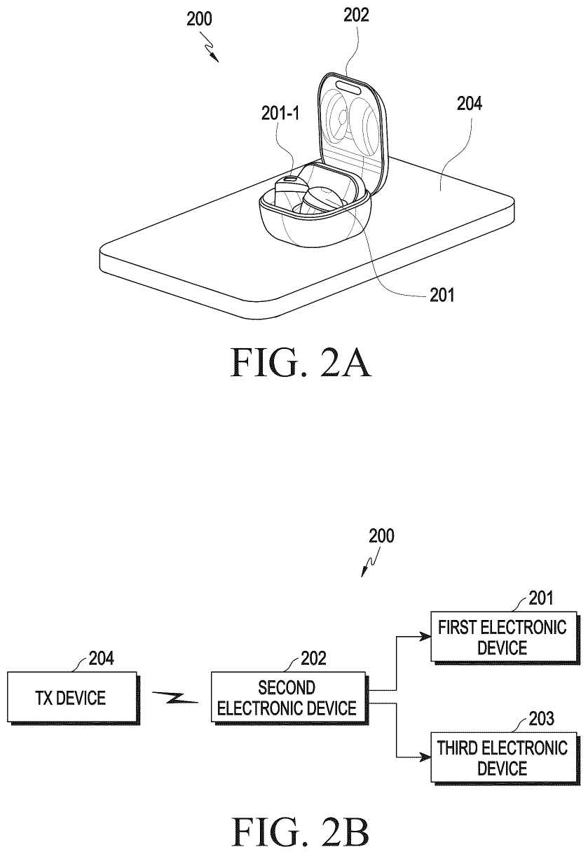

FIGS. 2A and 2B are diagrams illustrating a charging system according to one or more embodiments.

Referring to FIGS. 2A and 2B, a charging system 200 may include a first electronic device 201, a third electronic device 203, a second electronic device 202, and a wireless power transmission device (hereinafter, referred to as a TX device) 204. For example, each of the first electronic device 201, the third electronic device 203, the second electronic device 202, and the TX device 204 may be implemented to be identical or similar to the electronic devices 101, 102, and 104 of FIG. 1.

According to one or more embodiments, the first electronic device 201 may be implemented to be identical or similar to the third electronic device 203. Each of the first electronic device 201 and the third electronic device 203 may be implemented as a wearable electronic device (e.g., a wireless earphone or a smart ring). For example, the first electronic device 201 and the third electronic device 203 may be implemented as wearable electronic devices (e.g., wireless earphones and smart rings) that may be worn on the left ear and the right ear. Meanwhile, for convenience of description, it will be assumed that the first electronic device 201 and the third electronic device 203 are implemented as wireless earphones. However, the first electronic device 201 and the third electronic device 203 may not be limited thereto. For example, the first electronic device 201 and the third electronic device 203 may be implemented as various types of wearable electronic devices.

According to one or more embodiments, each of the first electronic device 201 and the third electronic device 203 may include a first interface including at least one terminal (e.g., a contact terminal). Each of the first electronic device 201 and the third electronic device 203 may receive power from the second electronic device through the first interface including at least one terminal. For example, each of the first electronic device 201 and the third electronic device 203 may be inserted or equipped in the second electronic device 202. In this case, at least one terminal included in each of the first electronic device 201 and the third electronic device 203 may contact at least one pin included in the second electronic device 202. For example, if the first electronic device 201 and the third electronic device 203 are inserted or equipped in the second electronic device 202, the first electronic device 201 and the third electronic device 203 may receive power from the second electronic device 202 through the first interface contacting at least one pin included in the second electronic device 202.

According to one or more embodiments, the housing of the second electronic device 202 may be implemented so that the first electronic device 201 and the third electronic device 203 are inserted or equipped in the housing. For example, the second electronic device 202 may be implemented as a cradle (or a charging case) of a wearable electronic device. For example, the second electronic device 202 may be implemented as a cradle (or a charging case) of a wireless earphone.

According to one or more embodiments, the second electronic device 202 may include a second interface including at least one pin (e.g., a POGO pin). The second electronic device 202 may transmit power to each of the first electronic device 201 and the third electronic device 203 through the second interface including at least one pin (e.g., a POGO pin). For example, if the first electronic device 201 and the third electronic device 203 are inserted or equipped in the second electronic device 202, the second electronic device 202 may transmit power to each of the first electronic device 201 and/or the third electronic device 203 through the second interface contacting the first electronic device 201 and/or the third electronic device 203 (or contacting the first interface). For example, the power transmitted by the second electronic device 202 to the first electronic device 201 and the third electronic device 203 may include power stored in the battery of the second electronic device 202 and/or power received from the TX device 204.

According to one or more embodiments, the second electronic device 202 may wirelessly receive power from the TX device 204. The second electronic device 202 may transmit power to the first electronic device 201 and/or the third electronic device 203 through the second interface including at least one pin (e.g., a POGO pin) while wirelessly receiving power from the TX device 204. For example, a portion of the power received by the second electronic device 202 from the TX device 204 may be transmitted to the first electronic device 201 and the third electronic device 203. Further, another portion of the power received by the second electronic device 202 from the TX device 204 may be supplied to the battery of the second electronic device 202.

According to one or more embodiments, the TX device 204 may wirelessly transmit power to the second electronic device 202. The TX device 204 may wirelessly transmit power to the second electronic device 202 according to at least one of an electromagnetic induction scheme or a magnetic resonance scheme. For example, the TX device 204 may be implemented as a TX pad. If the second electronic device 202 is positioned in the charging area (e.g., the charging area of the TX pad) of the TX device 204, the TX device 204 may wirelessly transmit power to the second electronic device 202. For example, the charging area of the TX device 204 may include a position where the wireless charging coil of the TX device 204 and the wireless charging coil of the second electronic device 202 are aligned.

In a state in which the second electronic device 202 wirelessly receives power from the TX device 204, the second electronic device 202 may transmit power to the first electronic device 201 and the third electronic device 203. In this case, the second electronic device 202 may operate the rectification circuit included in the second electronic device 202 as a full bridge circuit. According to the state of charge of the first electronic device 201 and the third electronic device 203, a constant current (CC) or a constant voltage (CV) may be supplied to the battery of the second electronic device 202. For example, before the first electronic device 201 and the third electronic device 203 are fully charged, a constant current may be supplied to the battery of the second electronic device 202. After the first electronic device 201 and the third electronic device 203 are fully charged, a constant current or a constant voltage may be supplied to the battery of the second electronic device 202. In the period in which the constant voltage is supplied to the battery of the second electronic device 202, the current supplied to the battery of the second electronic device 202 may gradually decrease. In this case, when the second electronic device 202 transmits power to a device having a small load, such as the first electronic device 201 and the third electronic device 203, the second electronic device 202 may operate the rectification circuit as a half bridge circuit for stability of the rectification circuit included in the second electronic device 202. For example, the second electronic device 202 may control the plurality of switches included in the rectification circuit to operate from a full bridge circuit to a half bridge circuit. However, the half bridge circuit may perform rectification by half compared to that of the full bridge circuit. As the full bridge circuit is changed to the half bridge circuit, the wireless charging efficiency of the second electronic device 202 may be reduced. Further, as the full bridge circuit is changed to the half bridge circuit, a heat generation issue of the second electronic device 202 may occur.

In order not to change the operation of the rectification circuit included in the second electronic device 202 from the full bridge circuit to the half bridge circuit, a dummy load may be included in the second electronic device 202. For example, when the second electronic device 202 includes a dummy load, the second electronic device 202 may conduct a constant current to the dummy load in a period in which a constant voltage is supplied to the battery of the second electronic device 202. However, when current is conducted to the dummy load, a heat generation issue of the second electronic device 202 may occur.

Given this, there may be required a method for operating the rectification circuit included in the second electronic device 202 as a full bridge circuit in a period in which a constant voltage is supplied to the battery of the second electronic device 202 without including a dummy load in the second electronic device 202.

The first electronic device 201 (or the third electronic device 203) according to various embodiments may include a dummy load. Further, when receiving power from the second electronic device 202 through the first interface in a state in which the second electronic device 202 wirelessly receives power from the TX device 204, the first electronic device 201 (or third electronic device 203) may conduct a direct current (DC) having a predetermined magnitude to the dummy load included in the first electronic device 201 (or the third electronic device 203) based on the state of charge (SOC) of the second electronic device 202. For example, the state of charge SOC of the second electronic device 202 may be information indicating the remaining battery capacity of the battery included in the second electronic device 202.

The charging system 200 according to various embodiments may not operate the rectification circuit of the second electronic device 202 as a half bridge circuit in a period in which a constant voltage is supplied to the battery of the second electronic device 202. For example, the second electronic device 202 may wirelessly receive power from the TX device 204 and perform battery charging while operating the rectification circuit as a full bridge circuit in a period in which a constant voltage is supplied to the battery of the second electronic device 202. Accordingly, the charging system 200 may increase wireless charging efficiency of the second electronic device 202 and minimize heat generation of the second electronic device 202.

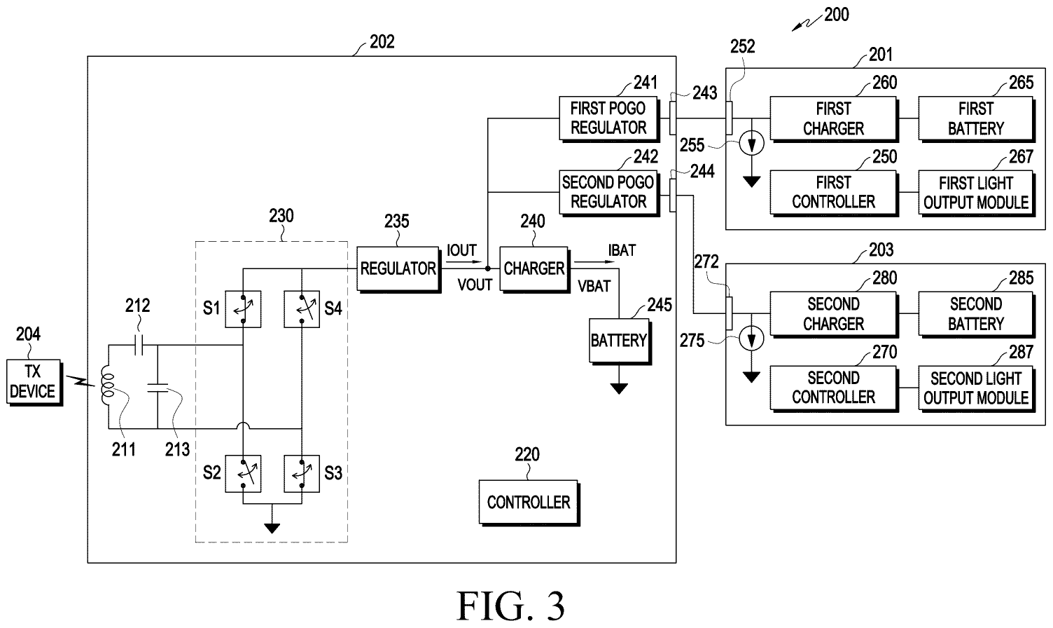

FIG. 3 is a block diagram illustrating a first electronic device, a second electronic device, a third electronic device, and a TX device according to one or more embodiments.

Referring to FIG. 3, according to one or more embodiments, a first electronic device 201 may include a first controller 250, a first interface 252, a first dummy load 255, a first charger 260, a first battery 265, and a first light output module 267. For example, the first electronic device 201 may be implemented as a wireless earphone that may be worn on the user's right ear or left ear.

According to one or more embodiments, the first controller 250 (e.g., the processor 120 of FIG. 1) may control the overall operation of the first electronic device 201. The first controller 250 may be implemented to be identical or similar to the processor 120 of FIG. 1.

According to one or more embodiments, the first controller 250 may receive power from the second electronic device 202 through the first interface 252. The first interface 252 may include at least one terminal (e.g., a contact terminal). For example, if the first electronic device 201 is inserted or equipped in the second electronic device 202, at least one terminal included in the first interface 252 may contact at least one pin included in the second interface 243 of the second electronic device 202. The first electronic device 201 may receive power from the second electronic device 202 in a state in which at least one terminal included in the first interface 252 contacts at least one pin included in the second interface 243 of the second electronic device 202. The first charger 260 may supply power received from the second electronic device 202 to the first battery 265.

According to one or more embodiments, the first controller 250 may receive a packet from the second electronic device 202 through the first interface 252 or may transmit the packet to the second electronic device 202 through the first interface 252. For example, the packet may be obtained based on a signal whose magnitude is modulated with respect to a reference voltage or a reference current. For example, the packet may include status information (e.g., temperature, mounting state, power transmission state, or battery state of charge) about the first electronic device 201 and the second electronic device 202 or may include a command (e.g., a command for controlling current or voltage) related to wireless power transmission.

According to one or more embodiments, the first controller 250 may identify the SOC of the second electronic device 202, based on the received packet. For example, the state of charge SOC may be information indicating the remaining capacity (or remaining battery capacity) of the battery 245 included in the second electronic device. For example, the state of charge SOC may include a value indicating the amount of power remaining in the current battery 245. For example, when the battery 245 is fully charged, the state of charge SOC may include a value indicating 100%. Alternatively, when the battery 245 is half charged, the state of charge SOC may include a value indicating 50%.

According to one or more embodiments, when the first battery 265 is fully charged, the first controller 250 may periodically conduct an alternating current (AC) having a predetermined magnitude to the first dummy load 255. For example, the AC may have a magnitude of 0 mA to 5 mA. The first controller 250 may periodically turn on/off the AC with respect to the first dummy load 255. The first electronic device 201 may receive a predetermined level of power from the second electronic device 202 even if the first battery 265 is fully charged. However, the first controller 250 may not supply current to the first battery 265 in a state in which the first battery 265 is fully charged. In this case, the first controller 250 may periodically conduct an AC to the first dummy load 255 based on a predetermined level of power received from the second electronic device 202.

According to one or more embodiments, the first controller 250 may identify whether the state of charge SOC of the second electronic device 202 is larger than a predetermined value. For example, the predetermined value may be determined by the user, determined by the second electronic device 202, or determined by the first controller 250. For example, the predetermined value may be a value (or a value indicated by the state of charge) in which a stability issue of the rectification circuit 230 may occur when the rectification circuit 230 is maintained as a full bridge circuit.

According to one or more embodiments, the first controller 250 may conduct a DC having a predetermined magnitude to the first dummy load 255, based on identifying that the state of charge of the second electronic device 202 is larger than the predetermined value in the state in which the first battery 265 is fully charged. For example, the DC may have a magnitude of 10 mA to 20 mA. For example, the magnitude of the DC may be changed in the range of 10 mA to 20 mA. For example, the first controller 250 may conduct a DC instead of an AC that used to be periodically conducted to the first dummy load 255. The first controller 250 may continuously conduct a DC having a predetermined magnitude to the first dummy load 255 until the battery 245 of the second electronic device 202 is fully charged.

According to one or more embodiments, the first controller 250 may output light through the first light output module 267, based on identifying that the state of charge of the second electronic device 202 is larger than the predetermined value in the state in which the first battery 265 is fully charged. For example, the first light output module 267 may include an optical element for outputting light. The first controller 250 may output light through the first light output module 267 without conducting a DC to the first dummy load 255. Alternatively, the first controller 250 may output light through the light output module 267 while conducting a DC to the first dummy load 255.

According to one or more embodiments, based on a first command received from the second electronic device 202 in a state in which the first battery 265 is fully charged, the first controller 250 may conduct a DC having a predetermined magnitude to the first dummy load 255 or may output light through the light output module 267.

According to one or more embodiments, if it is identified that the battery 245 included in the second electronic device 202 is fully charged, the first controller 250 may stop conducting the DC to the first dummy load 255. Thereafter, the first controller 250 may periodically conduct an AC having a predetermined magnitude to the first dummy load 255. In this case, the magnitude of the AC may be smaller than the magnitude of the DC.

According to one or more embodiments, if power reception from the second electronic device 202 is stopped, the first controller 250 may stop conducting the DC to the first dummy load 255. In this case, the first controller 250 may not conduct an AC to the first dummy load 255.

According to one or more embodiments, if it is identified that the battery 245 included in the second electronic device 202 is fully charged or power reception from the second electronic device 202 is stopped, the first controller 250 may stop the light output of the light output module 267.

According to one or more embodiments, based on a second command received from the second electronic device 202 after the battery 245 included in the second electronic device 202 is fully charged, the first controller 250 may stop conducting the DC to the first dummy load 255 or stop outputting the light.

According to one or more embodiments, the third electronic device 203 may include a second controller 270, a third interface 272, a second dummy load 275, a second charger 280, a second battery 285, and a second light output module 287. For example, the third electronic device 203 may be implemented as a wireless earphone that may be worn on the user's right ear or left ear. The third electronic device 203 may be implemented to be identical or similar to the first electronic device 201 except for the direction in which the third electronic device 203 is worn on the user's ear.

According to one or more embodiments, the second controller 270 may be implemented to be identical or similar to the first controller 250, the third interface 272 may be implemented to be identical or similar to the first interface 252, the second dummy load 275 may be implemented to be identical or similar to the first dummy load 255, the second charger 280 may be implemented to be identical or similar to the first charger 260, the second battery 285 may be implemented to be identical or similar to the first battery 265, and the second light output module 287 may be implemented to be identical or similar to the first light output module 267.

According to one or more embodiments, the second electronic device 202 may include a coil 211, a first capacitor 212, a second capacitor 213, a controller 220, a rectification circuit 230, a regulator 235, a charger 240, a battery 245, a first POGO regulator 241, a second POGO regulator 242, a second interface 243, and a fourth interface 244.

According to one or more embodiments, the controller 220 may control the overall operation of the second electronic device 202. The controller 220 may be implemented to be identical or similar to the processor 120 of FIG. 1.

According to one or more embodiments, the controller 220 may wirelessly receive power from the TX device 204 through the coil 211. The controller 220 may transmit power to the first electronic device 201 through the second interface 243 while wirelessly receiving power from the TX device 204. Further, the controller 220 may transmit power to the third electronic device 203 through the fourth interface 244 while wirelessly receiving power from the TX device 204.

According to one or more embodiments, the coil 211, the first capacitor 212, and the capacitor 213 may constitute a resonant circuit. The first capacitor 212 may be connected in series with the coil 211. One end of the first capacitor 212 may be connected to the coil 211, and the other end of the first capacitor 212 may be connected to the second capacitor and the rectification circuit 230. The second capacitor 213 may be connected in parallel with the coil 211.

According to one or more embodiments, the rectification circuit 230 may operate as any one of a full bridge circuit, a half bridge circuit, or a diode circuit. The rectification circuit 230 may include a plurality of switches S1, S2, S3, and S4. Each of the plurality of switches S1, S2, S3, and S4 may be implemented as a metal oxide semiconductor field effect transistor (MOSFET). Meanwhile, the number or type of switches illustrated in FIG. 3 is merely an example, and embodiments may not be limited thereto.

According to one or more embodiments, the controller 220 may control the plurality of switches S1, S2, S3, and S4 so that the rectification circuit 230 operates as a full bridge circuit. For example, the controller 220 may short the first switch S1 and the third switch S3 and may open the second switch S2 and the fourth switch S4 during a first period. Further, the controller 220 may open the first switch S1 and the third switch S3 and short the second switch S2 and the fourth switch S4 during a second period after the first period. The controller 220 may operate the rectification circuit 230 as a full bridge circuit by repeating the above-described operation on the plurality of switches S1, S2, S3, and S4.

According to one or more embodiments, the controller 220 may receive power from the TX device 204 while maintaining the rectification circuit 230 as a full bridge circuit until the battery 245 is fully charged. The controller 220 may operate the rectification circuit 230 as a half bridge circuit after the battery 245 is fully charged. Thereafter, when the battery 245 is recharged, the controller 220 may change the rectification circuit 230 to a full bridge circuit and may receive power from the TX device 204 using the changed full bridge circuit.

According to one or more embodiments, the controller 220 may rectify the power received from the coil 211 through the rectification circuit 230 and supply the rectified power to the regulator 235. The regulator 235 may be implemented as a low dropout (LDO).

According to one or more embodiments, the regulator 235 may convert (e.g., buck-convert and/or boost-convert) and/or regulate the voltage of the rectified power output from the rectification circuit 230.

According to one or more embodiments, the charger (or charging circuit) 240 may charge the battery 245 using power converted and/or regulated by the regulator 235. For example, the charger 240 may control a voltage and/or a current for charging the battery 245 according to a charging mode (e.g., a CC mode, a CV mode, or a quick charge mode) of the battery 245. According to one or more embodiments, a PMIC in place of the charger 240 may be coupled to the regulator 235.

According to one or more embodiments, the controller 220 may provide power to the first electronic device 201 and/or the third electronic device 203 using the power converted and/or regulated by the regulator 235. The controller 220 may transmit power converted and/or regulated by the first POGO regulator 241 to the first electronic device 201 through the second interface 243. The controller 220 may transmit power converted and/or regulated by the second POGO regulator 242 to the third electronic device 203 through the fourth interface 244. For example, the first POGO regulator 241 and the second POGO regulator 242 may be implemented as LDOs.

According to one or more embodiments, the controller 220 may transmit a packet through the second interface 243. The controller 220 may transmit a packet to the first electronic device 201 using power (e.g., a current signal or a voltage signal) converted and/or modulated to be larger than a reference voltage or a reference current by the first POGO regulator 241. Further, the controller 220 may transmit a packet to the third electronic device 203 using power (e.g., a current signal or a voltage signal) converted and/or modulated to be larger than a reference voltage or a reference current by the second POGO regulator 242.

According to one or more embodiments, the controller 220 may identify or monitor the magnitude of the current IOUT output from the regulator 235. Further, the controller 220 may identify or monitor the magnitude of the current IBAT provided from the charger 240 to the battery 245.

According to one or more embodiments, the controller 220 may identify or monitor the magnitude of the voltage VOUT output from the regulator 235. Further, the controller 220 may identify or monitor the magnitude of the voltage VBAT provided from the charger 240 to the battery 245.

According to one or more embodiments, the controller 220 may identify the state of charge of the battery 245 based on the magnitude of the current IBAT and/or voltage VBAT provided from the charger 240 to the battery 245. Alternatively, the controller 220 may obtain information about the state of charge of the battery 245 from the battery 245.

According to one or more embodiments, the controller 220 may transmit the first command to the first electronic device 201 and/or the third electronic device 203, based on the magnitude of the current IOUT output from the regulator 235. For example, the first command may be transmitted as a packet through the second interface 243 or the fourth interface 244.

According to one or more embodiments, the controller 220 may transmit information about the state of charge of the battery 245 to the first electronic device 201 through the second interface 243. Further, the controller 220 may transmit information about the state of charge of the battery 245 to the third electronic device 203 through the fourth interface 244. For example, information about the state of charge of the battery 245 may be transmitted as a packet through the second interface 243 or the fourth interface 244. If the state of charge of the battery 245 is changed, the controller 220 may transmit information about the changed state of charge to the first electronic device 201 and/or the third electronic device 203. Alternatively, the controller 220 may periodically transmit information about the state of charge to the first electronic device 201 and/or the third electronic device 203.

According to one or more embodiments, even if the state of charge of the battery 245 is larger than the predetermined value, the controller 220 may operate the rectification circuit 230 as a full bridge circuit until the battery 245 is fully charged. For example, the controller 220 may control the rectification circuit 230 so that the plurality of switches S1, S2, S3, and S4 included in the rectification circuit 230 operate as a full bridge circuit.

According to one or more embodiments, as the controller 220 transmits the state of charge of the battery 245 having a value larger than the predetermined value to the first electronic device 201, a DC having a predetermined magnitude may be transmitted to the first dummy load 255 of the first electronic device 201. Accordingly, the controller 220 may operate the rectification circuit 230 as a full bridge circuit until the battery 245 is fully charged.

According to one or more embodiments, the controller 220 may identify the magnitude of the current IOUT output from the regulator 235. For example, if it is identified that the magnitude of the current IOUT output from the regulator 235 is larger than the predetermined current value, the controller 220 may transmit the first command to the first electronic device 201 through the second interface 243. For example, the first command may refer to a command or an instruction for allowing the first electronic device 201 to conduct a DC having a predetermined magnitude to the first dummy load 255 included in the first electronic device 201. For example, the predetermined current value may be a predetermined current value (or the magnitude of the output current IOUT of the predetermined regulator 235) to prevent a stability issue of the rectification circuit 230 from occurring when the rectification circuit 230 is maintained as a full bridge circuit. Accordingly, the controller 220 may operate the rectification circuit 230 as a full bridge circuit until the battery 245 is fully charged. Similarly, if it is identified that the magnitude of the current IOUT applied to the charger (or charging circuit) 240 is larger than the predetermined current value, the controller 220 may transmit the first command to the third electronic device 203 through the fourth interface 244.

According to one or more embodiments, the controller 220 may determine whether the battery 245 is fully charged. For example, if it is identified that the battery 245 is fully charged, the controller 220 may transmit the second command to the first electronic device 201 through the second interface 243. For example, the second command may refer to a command or an instruction for allowing the first electronic device 201 to stop conducting a DC having a predetermined magnitude to the first dummy load 255. Accordingly, after the battery 245 is fully charged, the controller 220 may control the first electronic device 201 to allow the first electronic device 201 to stop conducting the DC to the first dummy load 255. Similarly, after the battery 245 is fully charged, the controller 220 may transmit the second command to the third electronic device 203 through the fourth interface 244.

According to one or more embodiments, even if the power state of the first battery 265 of the first electronic device 201 and the power state of the second battery 285 of the third electronic device 203 are different, the first electronic device 201 and the third electronic device 203 may independently perform the above-described operations. For example, when the first battery 265 of the first electronic device 201 is fully charged but the second battery 285 of the third electronic device 203 is not fully charged, the first electronic device 201 may conduct a DC to the first dummy load 255 based on the state of charge of the battery 245 of the second electronic device 202. In this case, the third electronic device 203 may supply power to the second battery 285 without conducting a DC to the second dummy load 275 until the second battery 285 is fully charged.

The technical features of the first electronic device 201 described below may be equally applied to the third electronic device 203. However, for convenience of description, a description of the operation of the third electronic device 203 is omitted.

At least some of the operations of the first electronic device 201 described below may be performed by the first controller 250. However, for convenience of description, it is described that the first electronic device 201 performs the corresponding operations. Further, at least some of the operations of the second electronic device 202 may be performed by the controller 220. However, for convenience of description, it is described that the second electronic device 202 performs the corresponding operations.

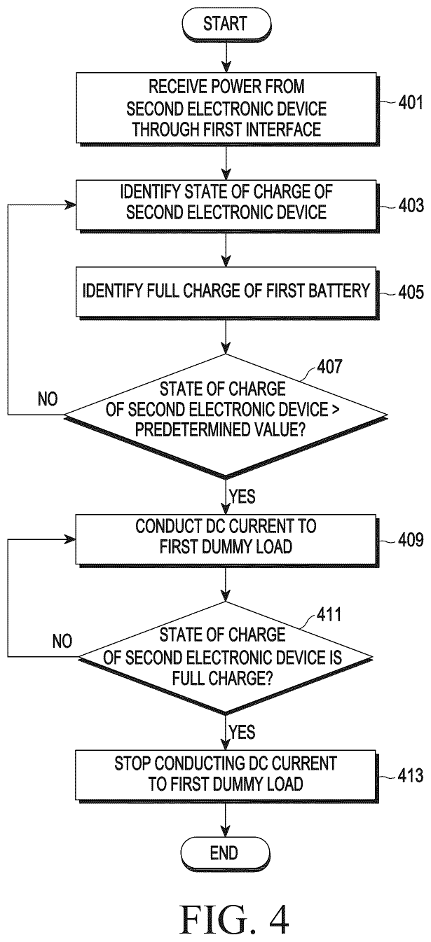

FIG. 4 is a flowchart illustrating a method for operating a first electronic device according to one or more embodiments.

Referring to FIG. 4, according to one or more embodiments, in operation 401, the first electronic device 201 may receive power from the second electronic device 202 through the first interface 252 in a state in which the second electronic device 202 wirelessly receives power through the TX device 204.

According to one or more embodiments, in operation 403, the first electronic device 201 may identify the state of charge of the second electronic device 202 (or the battery 450 of the second electronic device 202). The first electronic device 201 may receive a packet from the second electronic device 202 through the first interface 252. The first electronic device 201 may obtain information about the state of charge of the second electronic device 202 based on the packet received from the second electronic device 202.

According to one or more embodiments, in operation 405, the first electronic device 201 may identify that the first battery 265 included in the first electronic device 201 is fully charged. If the first battery 265 is fully charged, the first electronic device 201 may periodically conduct an AC having a predetermined magnitude to the first dummy load 255. The first electronic device 201 may not conduct current to the first dummy load 255 before the first battery 265 included in the first electronic device 201 is fully charged. Alternatively, according to one or more embodiments, before the first battery 265 included in the first electronic device 201 is fully charged, the first electronic device 201 may conduct a predetermined level of current (DC or AC) to the first dummy load 255 based on the state of charge of the first battery 265. In this case, the predetermined level of current may be smaller than the magnitude (e.g., the predetermined magnitude) of the current conducted to the first dummy load 255 when the first battery 265 is fully charged.

According to one or more embodiments, in operation 407, the first electronic device 201 may identify whether the state of charge of the second electronic device 202 is larger than the predetermined value.

According to one or more embodiments, when it is identified that the state of charge of the second electronic device 202 is not larger than the predetermined value (NO in 407), the first electronic device 201 may identify or monitor the state of charge of the second electronic device 202.

According to one or more embodiments, when it is identified that the state of charge of the second electronic device 202 is larger than the predetermined value (YES in 407), in operation 409, the first electronic device 201 may conduct a DC having a predetermined magnitude instead of an AC to the first dummy load 255. For example, the magnitude of the DC may be larger than the magnitude of the AC. For example, the first electronic device 201 may continuously conduct a DC having a predetermined magnitude to the first dummy load 255 until the battery 245 of the second electronic device 202 is fully charged.

According to one or more embodiments, in operation 411, the first electronic device 201 may identify whether the state of charge of the second electronic device 202 is fully charged. For example, the first electronic device 201 may identify whether the state of charge received from the second electronic device 202 indicates full charge (e.g., 100% charge). Alternatively, the first electronic device 201 may receive a value indicating full charge from the second electronic device 202 to identify that the state of charge of the second electronic device 202 is full charge.

According to one or more embodiments, if it is identified that the state of charge of the second electronic device 202 is not fully charged (NO in operation 411), the first electronic device 201 may continue to conduct the DC having the predetermined magnitude to the first dummy load 255 until it is identified that the battery 245 of the second electronic device 202 is fully charged.

According to one or more embodiments, when it is identified that the state of charge of the second electronic device 202 is fully charged (YES in operation 411), in operation 413, the first electronic device 201 may stop conducting the DC to the first dummy load 255.

According to one or more embodiments, the order of operations of the first electronic device 201 described above may be changed. Further, according to one or more embodiments, some of the above-described operations of the first electronic device 201 may be omitted.

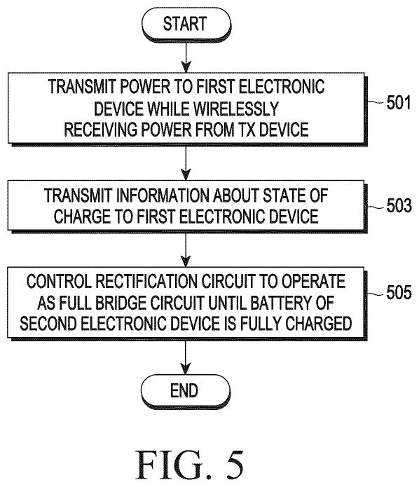

FIG. 5 is a flowchart illustrating a method for operating a second electronic device according to one or more embodiments.

Referring to FIG. 5, according to one or more embodiments, in operation 501, the second electronic device 202 may transmit power to the first electronic device 201 through the second interface 243 while wirelessly receiving power from the TX device 204.

According to one or more embodiments, in operation 503, the second electronic device 202 may transmit information about the state of charge of the battery 245 to the first electronic device 201. The second electronic device 202 may transmit, through the second interface 243, information about the state of charge of the battery 245 to the first electronic device 201 as a packet.

According to one or more embodiments, in operation 505, the second electronic device 202 may control the rectification circuit 230 to allow the plurality of switches S1, S2, S3, and S4 to operate as a full bridge circuit until the battery 245 is fully charged. For example, the second electronic device 202 may operate the rectification circuit 230 as a full bridge circuit in a period in which a constant voltage is supplied to the battery 245. The second electronic device 202 may wirelessly receive power from the TX device 204 while maintaining the rectification circuit 230 as a full bridge circuit until the battery 245 is fully charged.

According to one or more embodiments, after the battery 245 is fully charged, the second electronic device 202 may control the rectification circuit 230 to allow the plurality of switches S1, S2, S3, and S4 to operate as half bridge circuits.

According to one or more embodiments, the order of operations of the second electronic device 202 described above may be changed. Further, according to one or more embodiments, some of the above-described operations of the second electronic device 202 may be omitted.

As shown in FIGS. 4 and 5, the first electronic device 201 may conduct a DC to the dummy load 255 based on the state of charge of the second electronic device 202. Further, the second electronic device 202 may maintain the rectification circuit 230 as a full bridge circuit until the battery 245 is fully charged. Accordingly, the charging system 200 may not operate the rectification circuit 230 of the second electronic device 202 as a half bridge circuit in a period in which a constant voltage is supplied to the battery 245 of the second electronic device 202. For example, the rectification circuit 230 of the second electronic device 202 may be operated as a full bridge circuit in a period in which a constant voltage is supplied to the battery 245 of the second electronic device 202. The second electronic device 202 may receive power from the TX device 204 and may charge the battery 245 while maintaining the rectification circuit 230 as a full bridge circuit until the battery 245 is fully charged.

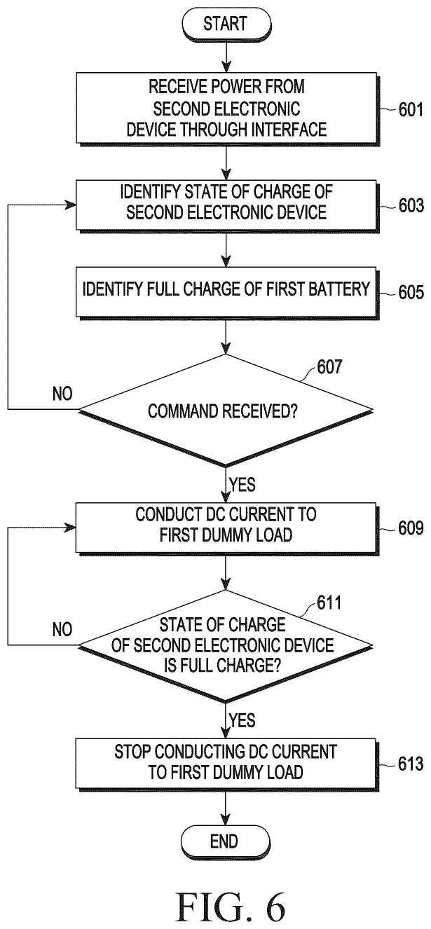

FIG. 6 is a flowchart illustrating a method for operating a first electronic device according to one or more embodiments.

Referring to FIG. 6, according to one or more embodiments, in operation 601, the first electronic device 201 may receive power from the second electronic device 202 through the first interface 252 in a state in which the second electronic device 202 wirelessly receives power through the TX device 204.

According to one or more embodiments, in operation 603, the first electronic device 201 may identify the state of charge of the second electronic device 202 (or the battery 450 of the second electronic device 202). For example, the information indicating the state of charge of the second electronic device 202 may be received as a packet from the second electronic device 202 through the first interface 252. The first electronic device 201 may obtain information about the state of charge of the second electronic device 202 based on the packet received from the second electronic device 202.

According to one or more embodiments, in operation 605, the first electronic device 201 may identify that the first battery 265 included in the first electronic device 201 is fully charged. If the first battery 265 is fully charged, the first electronic device 201 may periodically conduct an AC having a predetermined magnitude to the first dummy load 255. Further, the first electronic device 201 may transmit, to the second electronic device 202, information indicating that the first battery 265 is fully charged through the first interface 252. For example, the information indicating that the first battery 265 is fully charged may be transmitted as a packet through the first interface 252.

According to one or more embodiments, in operation 607, the first electronic device 201 may identify whether a first command is received from the second electronic device 202. For example, the first electronic device 201 may identify whether the first command is received, based on the packet received from the second electronic device 202.

According to one or more embodiments, if it is identified that the first command is not received from the second electronic device 202 (No in operation 607), the first electronic device 201 may periodically conduct an AC having a predetermined magnitude to the first dummy load 255.

According to one or more embodiments, when it is identified that the first command is received from the second electronic device 202 (YES in operation 607), in operation 609, the first electronic device 201 may conduct a DC having a predetermined magnitude instead of an AC to the first dummy load 255. For example, the magnitude of the DC may be larger than the magnitude of the AC. For example, the first electronic device 201 may continuously conduct a DC having a predetermined magnitude to the first dummy load 255 until the battery 245 of the second electronic device 202 is fully charged.

According to one or more embodiments, in operation 611, the first electronic device 201 may identify whether the state of charge of the second electronic device 202 is fully charged. For example, the first electronic device 201 may identify whether the state of charge received from the second electronic device 202 indicates full charge (e.g., 100% charge). Alternatively, the first electronic device 201 may receive a value indicating full charge from the second electronic device 202 to identify that the state of charge of the second electronic device 202 is full charge.

According to one or more embodiments, if it is identified that the state of charge of the second electronic device 202 is not fully charged (NO in operation 611), the first electronic device 201 may continue to conduct the DC having the predetermined magnitude to the first dummy load 255 until it is identified that the battery 245 of the second electronic device 202 is fully charged.

According to one or more embodiments, when it is identified that the state of charge of the second electronic device 202 is fully charged (YES in operation 611), in operation 613, the first electronic device 201 may stop conducting the DC to the first dummy load 255.

According to one or more embodiments, when receiving the second command from the second electronic device 202, the first electronic device 201 may determine that the state of charge of the second electronic device 202 is full charge. For example, if it is identified that the second command is received, the first electronic device 201 may stop conducting the DC to the first dummy load 255.

According to one or more embodiments, even if it is identified that the state of charge of the second electronic device 202 is full charge, the first electronic device 201 may stop conducting the DC to the first dummy load 255 only when the second command is received from the second electronic device 202.

According to one or more embodiments, the order of operations of the first electronic device 201 described above may be changed. Further, according to one or more embodiments, some of the above-described operations of the first electronic device 201 may be omitted.

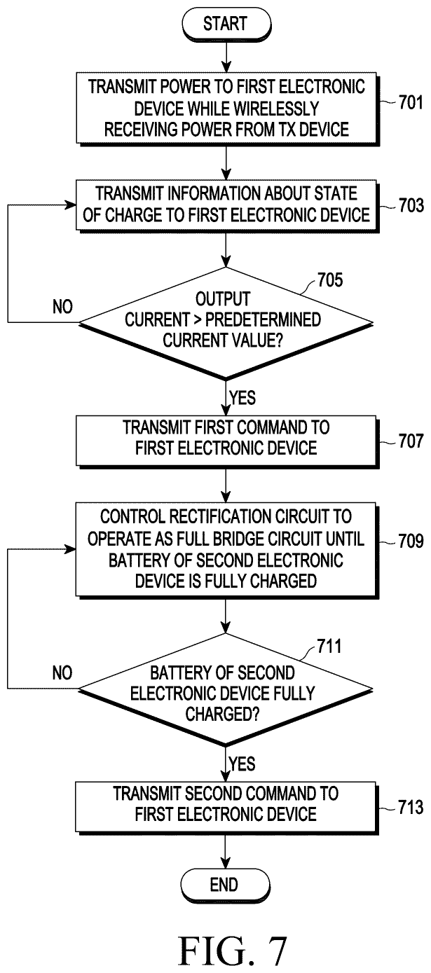

FIG. 7 is a flowchart illustrating a method for operating a second electronic device according to one or more embodiments.

According to one or more embodiments, in operation 701, the second electronic device 202 may transmit power to the first electronic device 201 through the second interface 243 while wirelessly receiving power from the TX device 204.

According to one or more embodiments, in operation 703, the second electronic device 202 may transmit information about the state of charge of the battery 245 to the first electronic device 201. In this case, the second electronic device 202 may transmit, through the second interface 243, information about the state of charge of the battery 245 as a packet.

According to one or more embodiments, in operation 705, the second electronic device 202 may identify whether the magnitude of the output current IOUT of the regulator 235 is larger than a predetermined current value.

According to one or more embodiments, if it is identified that the magnitude of the output current IOUT of the regulator 235 is not larger than the predetermined current value (NO in operation 705), the second electronic device 202 may periodically or in real time identify or monitor the magnitude of the current IOUT output from the regulator 235.

According to one or more embodiments, if it is identified that the magnitude of the output current IOUT of the regulator 235 is larger than the predetermined current value (YES in operation 705), in operation 707, the second electronic device 202 may transmit a first command to the first electronic device 201 through the second interface 243. The first electronic device 201 may conduct a DC of a predetermined magnitude to the first dummy load 255 according to the first command received from the second electronic device 202.

According to one or more embodiments, in operation 709, the second electronic device 202 may control the rectification circuit 230 to allow the plurality of switches S1, S2, S3, and S4 to operate as a full bridge circuit until the battery 245 is fully charged. For example, the second electronic device 202 may operate the rectification circuit 230 as a full bridge circuit in a period in which a constant voltage is supplied to the battery 245. The second electronic device 202 may wirelessly receive power from the TX device 204 while maintaining the rectification circuit 230 as a full bridge circuit until the battery 245 is fully charged.

According to one or more embodiments, in operation 711, the second electronic device 202 may identify whether the battery 245 of the second electronic device 202 is fully charged. If it is not identified that the battery 245 is fully charged (NO in operation 711), the second electronic device 202 may wirelessly receive power from the TX device 204 while maintaining the rectification circuit 230 as a full bridge circuit.

According to one or more embodiments, if it is identified that the battery 245 is fully charged (YES in operation 711), the second electronic device 202 may transmit the second command to the first electronic device 201 through the second interface 243. If it is identified that the second command is received, the first electronic device 201 may stop conducting the DC to the first dummy load 255.

According to one or more embodiments, after the battery 245 is fully charged, the second electronic device 202 may control the rectification circuit 230 to allow the plurality of switches S1, S2, S3, and S4 to operate as half bridge circuits.

According to one or more embodiments, the order of operations of the second electronic device 202 described above may be changed. Further, according to one or more embodiments, some of the above-described operations of the second electronic device 202 may be omitted.

As shown in FIGS. 6 and 7, the first electronic device 201 may conduct a DC to the dummy load 255 based on the first command received from the second electronic device 202. Further, the second electronic device 202 may maintain the rectification circuit 230 as a full bridge circuit until the battery 245 is fully charged. Accordingly, the charging system 200 may not operate the rectification circuit 230 of the second electronic device 202 as a half bridge circuit in a period in which a constant voltage is supplied to the battery 245 of the second electronic device 202. For example, the rectification circuit 230 of the second electronic device 202 may be operated as a full bridge circuit in a period in which a constant voltage is supplied to the battery 245 of the second electronic device 202. The second electronic device 202 may receive power from the TX device 204 and perform battery charging while maintaining the rectification circuit 230 as a full bridge circuit until the battery 245 is fully charged.

The charging system 200 may address a heat generation issue that may occur in a CV period when the second electronic device 202 wirelessly receives power.

When the second electronic device 202 wirelessly receives power from the TX device 204, if the second electronic device 202 and the TX device 204 is misaligned, charging efficiency may be reduced. In this case, if the rectification circuit 230 of the second electronic device 202 is operated as a half bridge circuit, a large amount of heat may be generated from the second electronic device 202. Since the charging system 200 operates the rectification circuit 230 of the second electronic device 202 as a full bridge circuit during wireless charging, the above-described heat generation issue may not occur. For this reason, the charging system may not perform a process (e.g., an operation of stopping charging and resuming charging) for protecting the battery 245 of the second electronic device 202, which may occur due to the above-described heat generation issue. The charging system 200 may minimize a control operation due to heat generation in various wireless charging situations as well as the above-described heat generation issue, secure a stable charging time, and shorten the charging completion time.

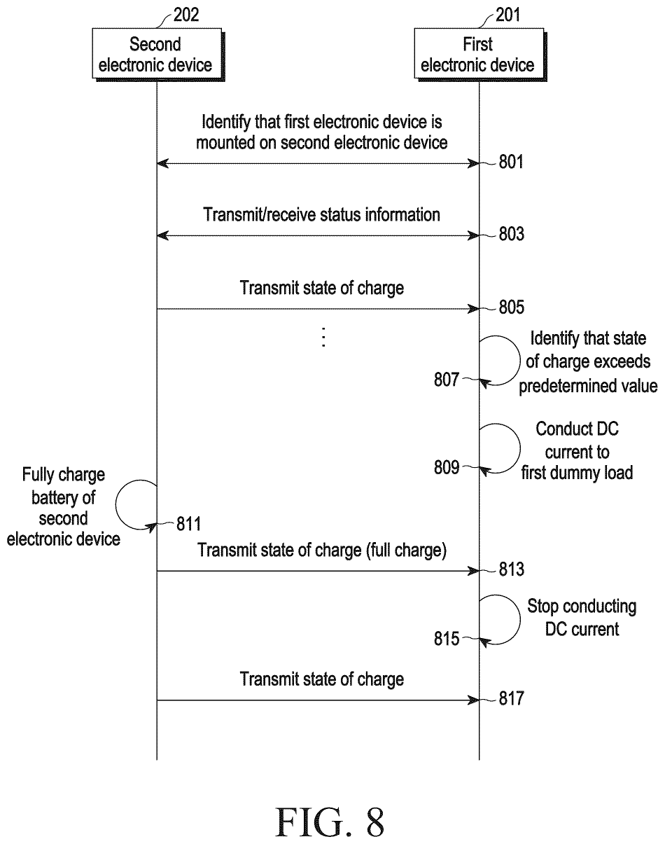

FIG. 8 is a diagram illustrating a data flow for illustrating data transmitted/received by a first electronic device and a second electronic device according to one or more embodiments.

Referring to FIG. 8, the first electronic device 201 may transmit/receive data to/from the second electronic device 202 through the first interface 252. Further, the second electronic device 202 may transmit/receive data to/from the first electronic device 201 through the second interface 243.

However, embodiments are not limited thereto. For example, when a separate communication circuit is included in each of the first electronic device 201 and the second electronic device 202, the first electronic device 201 may transmit/receive data to/from the second electronic device 202 through the separate communication circuit.

According to one or more embodiments, in operation 801, the second electronic device 202 may identify whether the first electronic device 201 is mounted on or equipped in the second electronic device 202. For example, when at least one pin included in the second interface 243 contacts at least one terminal included in the first interface 252, the second electronic device 202 may identify that the first electronic device 201 is mounted on or equipped in the second electronic device 202. Further, when the at least one terminal included in the first interface 252 contacts the at least one pin included in the second interface 243, the first electronic device 201 may identify that the at least one terminal is mounted on the second electronic device 202.

According to one or more embodiments, if it is identified that the first electronic device 201 is mounted or equipped, in operation 803, the second electronic device 202 may transmit/receive status information to/from the first electronic device 201. For example, the status information may include information about the temperature, mounting state, and power transmission state of the first electronic device 201 and information about the temperature, mounting state, and power transmission state of the second electronic device 202. The second electronic device 202 may prepare to transmit power based on the status information. Thereafter, the second electronic device 202 may transmit power to the first electronic device 201 through the second interface 243. According to one or more embodiments, when the first electronic device 201 is mounted, inserted, or equipped, and a predetermined condition (e.g., when the case of the second electronic device 202 is closed) is met, the second electronic device 202 may transmit power to the first electronic device 201 and/or may transmit/receive status information to/from the first electronic device 201.

According to one or more embodiments, in operation 805, the second electronic device 202 may transmit information about the state of charge of the battery 245 to the first electronic device 201. For example, when the state of charge of the battery 245 is changed, the second electronic device 202 may transmit information about the changed state of charge in real time or periodically.

According to one or more embodiments, in operation 807, the first electronic device 201 may identify that the state of charge of the second electronic device 202 exceeds the predetermined value. In operation 809, the first electronic device 201 may conduct a DC having a predetermined magnitude to the first dummy load 255, based on the state of charge exceeding the predetermined value.

According to one or more embodiments, the second electronic device 202 may charge the battery 245 in a state of operating the rectification circuit 230 as a full bridge circuit. The second electronic device 202 may operate the rectification circuit 230 as a full bridge circuit until the battery 245 is fully charged. In operation 811, the second electronic device 202 may identify that the battery 245 is fully charged. In operation 813, the second electronic device 202 may transmit, to the first electronic device 201, information about the state of charge indicating that the battery 245 is fully charged.

According to one or more embodiments, in operation 815, the first electronic device 201 may stop conducting the DC to the first dummy load 255, based on the state of charge indicating that the battery 245 is fully charged.

According to one or more embodiments, in operation 817, when the state of charge of the battery 245 is changed, the second electronic device 202 may transmit information about the changed state of charge to the first electronic device 201. Thereafter, the first electronic device 201 and the second electronic device 202 may be operated according to the above-described method.

Through the above-described method, the charging system 200 may not operate the rectification circuit 230 of the second electronic device 202 as a half bridge circuit in a period in which a constant voltage is supplied to the battery 245 of the second electronic device 202. For example, the rectification circuit 230 of the second electronic device 202 may be operated as a full bridge circuit in a period in which a constant voltage is supplied to the battery 245 of the second electronic device 202. The second electronic device 202 may receive power from the TX device 204 while maintaining the rectification circuit 230 as a full bridge circuit until the battery 245 is fully charged. Accordingly, the charging system 200 may increase the wireless charging efficiency of the second electronic device 202 and minimize the heat generation issue of the second electronic device 202.

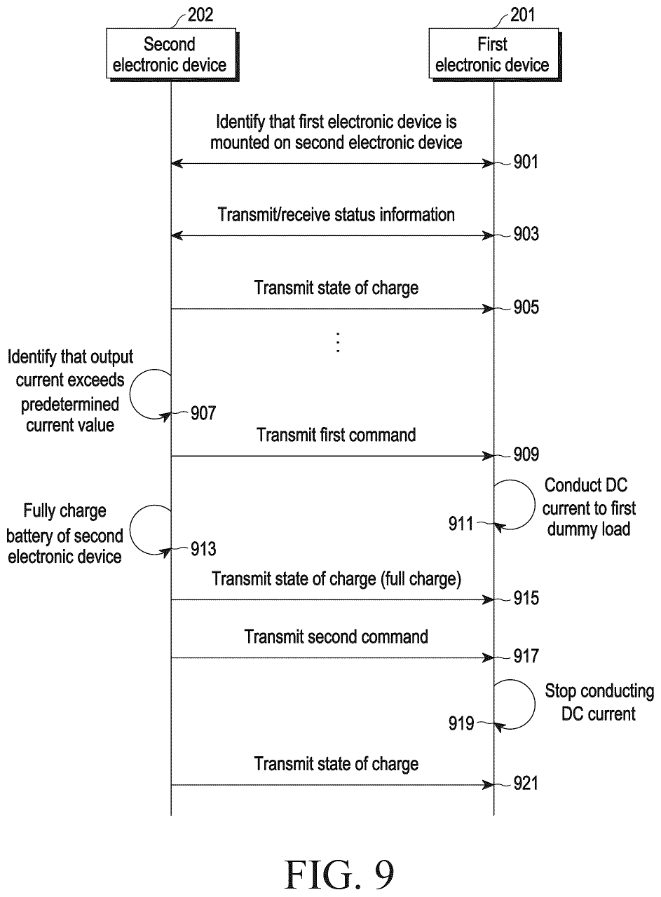

FIG. 9 is a diagram illustrating a data flow for illustrating data transmitted/received by a first electronic device and a second electronic device according to one or more embodiments.

Referring to FIG. 9, the first electronic device 201 may transmit/receive data to/from the second electronic device 202 through the first interface 252. Further, the second electronic device 202 may transmit/receive data to/from the first electronic device 201 through the second interface 243.

However, embodiments are not limited thereto. For example, when a separate communication circuit is included in each of the first electronic device 201 and the second electronic device 202, the first electronic device 201 may transmit/receive data to/from the second electronic device 202 through the separate communication circuit.

According to one or more embodiments, in operation 901, the second electronic device 202 may identify whether the first electronic device 201 is mounted on or equipped in the second electronic device 202. For example, when at least one pin included in the second interface 243 contacts at least one terminal included in the first interface 252, the second electronic device 202 may identify that the first electronic device 201 is mounted on or equipped in the second electronic device 202. Further, when the at least one terminal included in the first interface 252 contacts the at least one pin included in the second interface 243, the first electronic device 201 may identify that the at least one terminal is mounted on the second electronic device 202.

According to one or more embodiments, if it is identified that the first electronic device 201 is mounted or equipped, in operation 903, the second electronic device 202 may transmit/receive status information to/from the first electronic device 201. For example, the status information may include information about the temperature, mounting state, and power transmission state of the first electronic device 201 and information about the temperature, mounting state, and power transmission state of the second electronic device 202. The second electronic device 202 may prepare to transmit power based on the status information. Thereafter, the second electronic device 202 may transmit power to the first electronic device 201 through the second interface 243.

According to one or more embodiments, in operation 905, the second electronic device 202 may transmit information about the state of charge of the battery 245 to the first electronic device 201. For example, when the state of charge of the battery 245 is changed, the second electronic device 202 may transmit information about the changed state of charge in real time or periodically.

According to one or more embodiments, in operation 907, the second electronic device 202 may identify whether the output current IOUT of the regulator 235 is larger than a predetermined current value. In operation 909, the second electronic device 202 may transmit the first command to the first electronic device 201 based on the output current IOUT exceeding the predetermined current value. In operation 911, the first electronic device 201 may conduct a DC having a predetermined magnitude to the first dummy load 255, based on the first command.

According to one or more embodiments, the second electronic device 202 may charge the battery 245 in a state of operating the rectification circuit 230 as a full bridge circuit. The second electronic device 202 may operate the rectification circuit 230 as a full bridge circuit until the battery 245 is fully charged. In operation 913, the second electronic device 202 may identify that the battery 245 is fully charged. In operation 915, the second electronic device 202 may transmit, to the first electronic device 201, information about the state of charge indicating that the battery 245 is fully charged. In operation 917, if it is identified that the battery 245 is fully charged, the second electronic device 202 may transmit a second command to the first electronic device 201. However, according to one or more embodiments, the second electronic device 202 may not perform both operation 915 and operation 917. For example, the second electronic device 202 may perform at least one of operation 915 and operation 917.

According to one or more embodiments, in operation 919, the first electronic device 201 may stop conducting the DC to the first dummy load 255, based on at least one of the state of charge indicating that the battery 245 is fully charged or the second command. For example, if it is identified that both the state of charge indicating full charge of the battery 245 and the second command are received, the first electronic device 201 may stop conducting the DC to the first dummy load 255. Alternatively, e.g., if it is identified that any one of the state of charge indicating full charge of the battery 245 and the second command is received, the first electronic device 201 may stop conducting the DC to the first dummy load 255.

According to one or more embodiments, in operation 921, when the state of charge of the battery 245 is changed, the second electronic device 202 may transmit information about the changed state of charge to the first electronic device 201. Thereafter, the first electronic device 201 and the second electronic device 202 may be operated according to the above-described method.

Through the above-described method, the charging system 200 may not operate the rectification circuit 230 of the second electronic device 202 as a half bridge circuit in a period in which a constant voltage is supplied to the battery 245 of the second electronic device 202. For example, the rectification circuit 230 of the second electronic device 202 may be operated as a full bridge circuit in a period in which a constant voltage is supplied to the battery 245 of the second electronic device 202. The second electronic device 202 may receive power from the TX device 204 while maintaining the rectification circuit 230 as a full bridge circuit until the battery 245 is fully charged. Accordingly, the charging system 200 may increase the wireless charging efficiency of the second electronic device 202 and minimize the heat generation issue of the second electronic device 202.

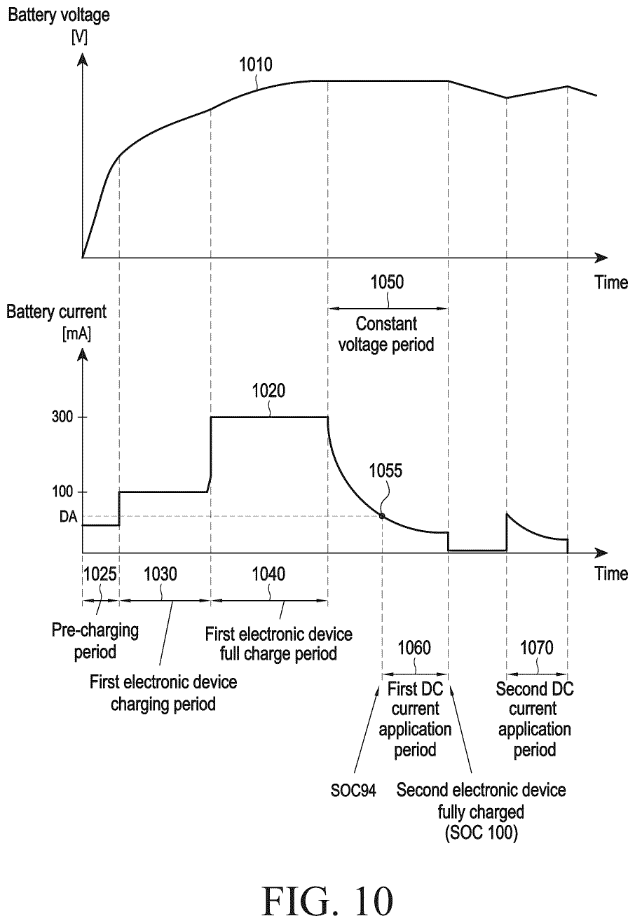

FIG. 10 illustrates graphs showing a battery voltage and a battery current of a second electronic device according to one or more embodiments.

Referring to FIG. 10, the battery voltage 1010 may refer to a battery voltage VBAT applied to the battery 245 included in the second electronic device 202 of FIG. 3. The battery current 1020 may refer to a battery current IBAT supplied to the battery 245 included in the second electronic device 202 of FIG. 3.

According to one or more embodiments, the second electronic device 202 may transmit power to the first electronic device 201 through the second interface 243 while wirelessly receiving power from the TX device 204.

According to one or more embodiments, in the state of wirelessly receiving power from the TX device 204, the second electronic device 202 may perform a preparatory operation for power transmission in a pre-charging period 1025 before transmitting power to the first electronic device 201.

According to one or more embodiments, the second electronic device 202 may transmit power to the first electronic device 201 in the first electronic device charging period 1030. For example, part of the power received by the second electronic device 202 from the TX device 204 may be transmitted to the first electronic device 201. Further, another portion of the power received by the second electronic device 202 from the TX device 204 may be supplied to the battery 245 of the second electronic device 202. In this case, the second electronic device 202 may supply a current having a first current value (e.g., 100 mA) to the battery 245.

According to one or more embodiments, the second electronic device 202 may supply a current having a second current value (e.g., 300 mA) to the battery 245 in the first electronic device full charge period 1040. For example, the second current value may be larger than the first current value. In this case, the second electronic device 202 may transmit a current (or power) having a magnitude smaller than that of the first electronic device charging period 1030 to the first electronic device 201 in the first electronic device full charge period 1040. The second electronic device 202 may gradually increase the magnitude of the battery voltage 1010 applied to the battery 245 from the pre-charging period 1025 to the first electronic device full charge period 1040.

According to one or more embodiments, the second electronic device 202 may apply a constant voltage (e.g., 4.42V) reaching a predetermined maximum voltage to the battery 245 in the constant voltage period 1050. The second electronic device 202 may gradually reduce the magnitude of the battery current 1020 supplied to the battery 245 in the constant voltage period 1050.

According to one or more embodiments, at one point 1055 included in the constant voltage period 1050, the first electronic device 201 may conduct a DC having a predetermined magnitude to the first dummy load 255. For example, one point 1055 may be a point at which the state of charge of the second electronic device 202 (or the battery 245) corresponds to a predetermined value (e.g., SOC 94%). Further, at one point 1055, the battery current 1020 may correspond to a predetermined current value DA. According to one or more embodiments, when the battery current 1020 reaches a point, the second electronic device 202 may transmit information about the state of charge of the second electronic device 202 to the first electronic device 201. According to one or more embodiments, when the battery current 1020 reaches a point 1055, the second electronic device 202 may transmit the first command to the first electronic device 201. The first electronic device 201 may conduct a DC having a predetermined magnitude to the first dummy load 255, based on at least one of the information about the state of charge or the first command received from the second electronic device 202 at the one point 1055. The first electronic device 201 may conduct a DC having a predetermined magnitude to the first dummy load 255 until the battery 245 of the second electronic device 202 is fully charged (e.g., SOC 100%). For example, the first electronic device 201 may conduct a DC having a predetermined magnitude to the first dummy load 255 in the first DC application period 1060.

According to one or more embodiments, if the state of charge of the battery 245 is changed (e.g., the power charged in the battery 245 is reduced) after the battery 245 is fully charged, the first electronic device 201 may again conduct a DC having a predetermined magnitude to the first dummy load 255. In this case, the second electronic device 202 may receive power from the TX device 204 while operating the rectification circuit 230 as a full bridge circuit. For example, the first electronic device 201 may conduct a DC having a predetermined magnitude to the first dummy load 255 in the second DC application period 1070.

Through the above-described method, the charging system 200 according to various embodiments may not operate the rectification circuit 230 of the second electronic device 202 as a half bridge circuit in a period 1050 in which a constant voltage is supplied to the battery 245 of the second electronic device 202. For example, the rectification circuit 230 of the second electronic device 202 may be operated as a full bridge circuit in a period 1050 in which a constant voltage is supplied to the battery 245 of the second electronic device 202. The second electronic device 202 may receive power from the TX device 204 while maintaining the rectification circuit 230 as a full bridge circuit until the battery 245 is fully charged. Accordingly, the charging system 200 may increase the wireless charging efficiency of the second electronic device 202 and minimize the heat generation issue of the second electronic device 202.

A first electronic device 201 according to one or more embodiments may include a first interface 252 including at least one terminal, a dummy load 255 electrically connected to the first interface, a first battery 265 electrically connected to the first interface and the dummy load, and a controller 250 operatively connected to the dummy load. The controller according to one or more embodiments may be configured to receive power from a second electronic device 202 through the first interface. The controller according to one or more embodiments may be configured to identify a state of charge of the second electronic device based on a packet received from the second electronic device through the first interface. The controller according to one or more embodiments may be configured to conduct a DC having a predetermined magnitude to the dummy load, based on identifying that the state of charge of the second electronic device is larger than a predetermined value in a state in which the first battery of the first electronic device is fully charged.

The controller according to one or more embodiments may be configured to conduct the DC to the dummy load until the second battery included in the second electronic device is fully charged.

The controller according to one or more embodiments may be configured to, when it is identified that the second battery included in the second electronic device is fully charged or power reception from the second electronic device is stopped, stop conducting the DC to the dummy load.

The controller according to one or more embodiments may be configured to periodically conduct an AC having a predetermined magnitude to the dummy load when the first battery is fully charged. The controller according to one or more embodiments may be configured to conduct the DC, instead of the AC, to the dummy load based on identifying that the state of charge of the second electronic device is larger than the predetermined value in the state in which the first battery is fully charged.

The controller according to one or more embodiments may be configured to obtain the packet by receiving a signal magnitude-modulated with respect to a reference voltage or a reference current from the second electronic device through the first interface.

The controller according to one or more embodiments may be configured to, when it is identified that the state of charge of the second electronic device is larger than the predetermined value in the state in which the first battery is fully charged, conduct the DC to the dummy load based on a command received from the second electronic device.

The controller according to one or more embodiments may be configured to obtain the command through the packet.

The controller according to one or more embodiments may be configured to output light through an optical element included in the first electronic device, based on identifying that the state of charge of the second electronic device is larger than the predetermined value in the state in which the first battery is fully charged.

The second electronic device according to one or more embodiments may be in a state of wirelessly receiving power from an outside.

The first electronic device according to one or more embodiments may be implemented as a wireless earphone, and the second electronic device is implemented as a cradle on which the wireless earphone is mounted.

A method for operating a first electronic device 201 according to one or more embodiments may include receiving power from a second electronic device 202 through a first interface 252 including at least one terminal included in the first electronic device. The method for operating the first electronic device 201 according to one or more embodiments may include identifying a state of charge of the second electronic device based on a packet received from the second electronic device through the first interface. The method for operating the first electronic device 201 according to one or more embodiments may include conducting a DC having a predetermined magnitude to a dummy load 255 included in the first electronic device, based on identifying that the state of charge of the second electronic device is larger than a predetermined value in a state in which a first battery 265 included in the first electronic device is fully charged.

The method for operating the first electronic device 201 according to one or more embodiments may further include conducting the DC to the dummy load until the second battery included in the second electronic device is fully charged.

The method for operating the first electronic device 201 according to one or more embodiments may further include, when it is identified that the second battery included in the second electronic device is fully charged or power reception from the second electronic device is stopped, stopping conducting the DC to the dummy load.

Conducting the DC to the dummy load according to one or more embodiments may include periodically conducting an AC having a predetermined magnitude to the dummy load when the first battery is fully charged. Conducting the DC to the dummy load may include conducting the DC, instead of the AC, to the dummy load based on identifying that the state of charge of the second electronic device is larger than the predetermined value in the state in which the first battery is fully charged.

Identifying the state of charge according to one or more embodiments may include obtaining the packet by receiving a signal magnitude-modulated with respect to a reference voltage or a reference current from the second electronic device through the first interface.

Conducting the DC to the dummy load according to one or more embodiments may include, when it is identified that the state of charge of the second electronic device is larger than the predetermined value in the state in which the first battery is fully charged, conducting the DC to the dummy load based on a command received from the second electronic device.

The method for operating the first electronic device 201 according to one or more embodiments may further include outputting light through an optical element included in the first electronic device, based on identifying that the state of power of the second electronic device is larger than the predetermined value in the state in which the first battery is fully charged.

A second electronic device 292 according to one or more embodiments may include a coil 211, a second interface 243 including at least one pin, a rectification circuit 230 including a plurality of switches electrically connected to the coil, a regulator 235 electrically connected to the rectification circuit, a second battery 245 electrically connected to the regulator, and a second controller 220. The second controller according to one or more embodiments may be configured to transmit power to a first electronic device 201 through the second interface while wirelessly receiving power from an external electronic device 204 through the coil. According to one or more embodiments, the second controller may be configured to transmit information about a state of charge of the second battery to the first electronic device through the second interface. The second controller according to one or more embodiments may be configured to transmit a first command to the first electronic device to allow the first electronic device to conduct a DC having a predetermined magnitude to a dummy load 255 included in the first electronic device when a magnitude of a current output from the regulator is larger than a predetermined current value. The second controller according to one or more embodiments may be configured to control the rectification circuit so that the plurality of switches operate as a full bridge circuit until the second battery is fully charged, even if the state of charge of the second battery is larger than a predetermined value.

The second controller according to one or more embodiments may be configured to transmit a second command to the first electronic device to allow the first electronic device to stop conducting the DC to the dummy load included in the first electronic device when the second battery is fully charged.

The second controller according to one or more embodiments may be configured to control the rectification circuit to allow the plurality of switches to operate as the full bridge circuit while a constant voltage is applied to the second battery.

In a charging system 200 including a first electronic device 201 and a second electronic device 202, according to one or more embodiments, the first electronic device may include a first interface 252 including at least one terminal, a dummy load 255 electrically connected to the first interface, a first battery 265 electrically connected to the first interface and the dummy load, and a first controller 250 operatively connected to the dummy load, the controller may be configured to receive power from a second electronic device through the first interface, identify a state of charge of the second electronic device based on a packet received from the second electronic device through the first interface, and conduct a DC having a predetermined magnitude to the dummy load, based on identifying that the state of charge of the second electronic device is larger than a predetermined value in a state in which the first battery of the first electronic device is fully charged, and the second electronic device may include a coil 211, a second interface 243 including at least one pin, a rectification circuit 230 including a plurality of switches electrically connected to the coil, a second battery 245 electrically connected to the rectification circuit, and a second controller 220 operatively connected to the second battery and may be configured to transmit power to a first electronic device through the second interface while wirelessly receiving power from an external electronic device 204 through the coil, transmit information about a state of charge of the second battery to the first electronic device through the second interface, and control the rectification circuit to allow the plurality of switches to operate as a full bridge circuit until the second battery is fully charged even if the state of charge of the second battery is larger than a predetermined value.

A non-transitory recording medium 130 according to one or more embodiments may store instructions capable of executing receiving power from a second electronic device 202 through a first interface 252 including at least one terminal included in a first electronic device 201, identifying a SOC of the second electronic device based on a packet received from the second electronic device through the first interface, and conducting a DC having a predetermined magnitude to a dummy load 255 included in the first electronic device based on identifying that the state of charge of the second electronic device is larger than a predetermined value in a state in which a first battery 265 included in the first electronic device is fully charged.

A non-transitory recording medium 130 according to one or more embodiments may store instructions capable of executing transmitting power to a first electronic device 201 through a second interface 243 included in a second electronic device 202 while wirelessly receiving power from an external electronic device 204 through a coil 211 included in the second electronic device 202, transmitting information about a state of charge of the second battery to the first electronic device through the second interface, when a magnitude of a current output from a regulator 235 included in the second electronic device 202 is larger than a predetermined current value, transmitting a first command to the first electronic device to allow the first electronic device to conduct a DC having a predetermined magnitude to a dummy load 255 included in the first electronic device, and controlling a rectification circuit 230 included in the second electronic device 202 to allow a plurality of switches included in the rectification circuit to operate as a full bridge circuit until the second battery is fully charged even if the state of charge of the second battery 245 included in the second electronic device 202 is larger than a predetermined value.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A first electronic device, comprising:
a first interface;
a dummy load connected to the first interface;
a first battery connected to the first interface and the dummy load; and
a controller connected to the dummy load,
wherein the controller is configured to:
receive power from a second electronic device through the first interface;
identify a state of charge (SOC) of the second electronic device based on a packet received from the second electronic device through the first interface; and
based on identifying that the SOC of the second electronic device is larger than a predetermined value and that the first battery is fully charged, conduct a direct current (DC) having a predetermined magnitude to the dummy load.

2. The first electronic device of claim 1, wherein the controller is configured to conduct the DC to the dummy load until a second battery of the second electronic device is fully charged.

3. The first electronic device of claim 2, wherein the controller is further configured to, based on the second battery being fully charged or power reception from the second electronic device being stopped, stop conducting the DC to the dummy load.

4. The first electronic device of claim 1, wherein the controller is further configured to:
based on the first battery being fully charged, periodically conduct an alternating current (AC) having a predetermined magnitude to the dummy load; and
based on identifying that the SOC of the second electronic device is larger than the predetermined value and that the first battery is fully charged, conduct the DC to the dummy load and stop conducting the AC to the dummy load.

5. The first electronic device of claim 1, wherein the controller is further configured to obtain the packet by receiving a signal magnitude-modulated with respect to a reference voltage or a reference current from the second electronic device through the first interface.

6. The first electronic device of claim 1, wherein the controller is configured to conduct the DC to the dummy load based on a command received from the second electronic device.

7. The first electronic device of claim 6, wherein the controller is further configured to obtain the command through the packet.

8. The first electronic device of claim 1, wherein the first electronic device further comprises an optical element, and
wherein the controller is configured to output light through the optical element based on identifying that the SOC of the second electronic device is larger than the predetermined value and that the first battery is fully charged.

9. The first electronic device of claim 1, wherein the second electronic device is configured to wirelessly receive power from an outside.

10. The first electronic device of claim 1, wherein the first electronic device comprises a wireless earphone, and
wherein the second electronic device comprises a cradle on which the wireless earphone is mounted.

11. A method of operating a first electronic device, the first electronic device comprising a first interface, a dummy load, and a first battery, the method comprising:
receiving power from a second electronic device through the first interface of the first electronic device;
identifying a state of charge (SOC) of the second electronic device based on a packet received from the second electronic device through the first interface; and
based on identifying that the SOC of the second electronic device is larger than a predetermined value and that the first battery is fully charged, conducting a direct current (DC) having a predetermined magnitude to the dummy load.

12. The method of claim 11, further comprising conducting the DC to the dummy load until a second battery of the second electronic device is fully charged.

13. The method of claim 12, further comprising, based on the second battery being fully charged or power reception from the second electronic device being stopped, stopping conducting the DC to the dummy load.

14. The method of claim 11, wherein conducting the DC to the dummy load comprises:
based on the first battery being fully charged, periodically conducting an alternating current (AC) having a predetermined magnitude to the dummy load; and
based on identifying that the SOC of the second electronic device is larger than the predetermined value and that the first battery is fully charged, conducting the DC to the dummy load and stopping conducting the AC to the dummy load.

15. The method of claim 11, wherein identifying the SOC of the second electronic device comprises obtaining the packet by receiving a signal magnitude-modulated with respect to a reference voltage or a reference current from the second electronic device through the first interface.

16. The method of claim 11, wherein conducting the DC to the dummy load comprises conducting the DC to the dummy load based on a command received from the second electronic device.

17. The method of claim 11, further comprising:
outputting light through an optical element included in the electronic device based on identifying that the SOC of the second electronic device is larger than the predetermined value and that the first battery is fully charged.

18. A second electronic device, comprising:
a coil;
a second interface;
a rectifier circuit including a plurality of switches connected to the coil;
a regulator connected to the rectifier circuit;
a second battery connected to the regulator; and
a controller connected to the second battery, wherein the controller is configured to:
while wirelessly receiving power from an external electronic device through the coil, transmit power to a first electronic device through the second interface,
transmit information on a state of charge (SOC) of the second battery to the first electronic device through the second interface,
when a size of current output from the regulator is greater than a designated current value, transmit a first command to the first electronic device so that the first electronic device conducts a direct current (DC) having a designated size to a dummy load included in the first electronic device, and
control the rectifier circuit so that the plurality of switches operate as a full bridge circuit until the second battery is fully charged when the SOC of the second battery is greater than a designated value.

19. The second electronic device of claim 18, wherein the controller is configured to:
transmit a second command to the first electronic device so that, when the second battery is fully charged, the first electronic device stops conducting the DC to the dummy load included in the first electronic device.

20. The second electronic device of claim 18, wherein the controller is configured to:
control the rectifier circuit so that, while a constant voltage is applied to the second battery, the plurality of switches operate as the full bridge circuit.
